(19) United States
(12) Patent Application Publication
(10) Pub. No.: US 2014/0043357 A1
(43) Pub. Date: Feb. 13, 2014

(54) DISPLAY DEVICE AND DISPLAY METHOD

(71) Applicants: Asahi Yamato, Osaka-shi (JP); Ken Inada, Osaka-shi (JP); Taketoshi Nakano, Osaka-shi (JP); Toshihiro Yanagi, Osaka-shi (JP)

(72) Inventors: Asahi Yamato, Osaka-shi (JP); Ken Inada, Osaka-shi (JP); Taketoshi Nakano, Osaka-shi (JP); Toshihiro Yanagi, Osaka-shi (JP)

(73) Assignee: SHARP KABUSHIKI KAISHA, Osaka-shi, Osaka (JP)

(21) Appl. No.: 14/009,598

(22) PCT Filed: Apr. 4, 2012
(86) PCT No.: PCT/JP2012/059198

§ 371 Date: Oct. 3, 2013

(30) Foreign Application Priority Data
Apr. 8, 2011 (JP) 2011-086819

(51) Int. Cl. G09G 5/02

(52) U.S. Cl. CPC G09G 5/02
USPC 345/603

(57) ABSTRACT

The display device (100) including a display panel (20) including pixels (21) each of which includes a red (R) sub pixel (22), a green (G) sub pixel (23), a blue (B) sub pixel (24), and white (W)sub pixel (25), the display device (100) includes an RGB data obtaining section (110) for obtaining RGB data; and a first calculating section (1 12a) for setting luminance of a white (W) sub pixel of one pixel (21) of the pixels (21) to be substantially identical with luminance of white sub pixels of some pixels (21) of the pixels (21) in the case where the RGB data obtained by the obtaining section (100) is converted into RGBX data for each pixel.

### TECHNICAL FIELD

The present invention relates to a display device which includes a display panel including pixels each of which includes four sub pixels, and, particularly to a display device which has been improved in displaying outlines of a displayed image.

### BACKGROUND ART

In general, a color image display device expresses various colors by mixing three colors of R (red), G (green), and B (blue). For example, each pixel of a display panel is provided with R, G, and B color filters, and light from a backlight is transmitted through these color filters so that light of R, G, and B is emitted.

Recently, there is known a technique in which each pixel is provided with a W (white) sub pixel in addition to R, G, and B sub pixels. In this case, image data obtained by a color image display device is normally in the form of RGB data. Accordingly, it is necessary to convert the image data into data corresponding to a pixel of RGBW.

For example, Patent Literature 1 describes a method in which a liquid crystal display device having RGBW pixel sequences converts RGB data into RGBW data.

### CITATION LIST

### Patent Literature 1

International Patent Publication WO 2006/080237 (Publication date: Jan. 19, 2006)

### SUMMARY OF INVENTION

### Technical Problem

However, in the case where a display device performs display with use of pixels each including four sub pixels, the display device unclearly displays outlines of an image, as compared with a conventional display panel each pixel of which is constituted by three sub pixels (RGB). For example, Patent Literature 1 discloses a technique that tone values of W sub pixels can be independently determined in accordance with tones of corresponding RGB sub pixels. Therefore, outlines of an image are changed among pixels, which results in degradation of a display quality. This makes outlines of a displayed image unclear.

The present invention has been made in view of the above problems, and an object of the present invention is to provide a display device including a display panel each pixel of which is constituted by four sub pixels, which display device is capable of clearly displaying of outlines of a displayed image.

### Solution to Problem

In order to achieve the above object, a display device in accordance with the present invention, which includes a display panel including pixels each of which includes a red (R) sub pixel, a green (G) sub pixel, a blue (B) sub pixel, and a fourth sub pixel (X), the display device includes: obtaining means for obtaining RGB data; and first converting means for setting luminance of a fourth sub pixel (X) of one pixel of the pixels to be substantially identical with luminance of fourth sub pixels (X) of some pixels of the pixels in the case where the RGB data obtained by the obtaining means is converted into RGBX data for each pixel, the one pixel and the some pixels being located in a predetermined region.

Further, in order to achieve the above object, a display method with use of a display device in accordance with the present invention, which includes a display panel including pixels each of which includes a red (R) sub pixel, a green (G) sub pixel, a blue (B) sub pixel, and a fourth sub pixel (X), the method includes the steps of: obtaining RGB data; and setting luminance of a fourth sub pixel (X) of one pixel of the pixels to be substantially identical with luminance of fourth sub pixels (X) of some pixels of the pixels in the case where the RGB data obtained by the obtaining means is converted into RGBX data for each pixel, the one pixel and the some pixels being located in a predetermined region.

In the display device (display method) in accordance with the present invention, in the case where the first converting means (conversion step) converts the RGB data obtained by the obtaining means (obtaining step) into the RGBX data, the first converting means sets luminance of the fourth sub pixel (X) of the one pixel to be substantially identical with that of the fourth sub pixels (X) of the some pixels, the one pixel and the some pixels being located in a predetermined region.

Therefore, in the display device (display method) in accordance with the present invention, the luminance of the fourth sub pixel (X) of the one pixel is substantially identical with that of the fourth sub pixels (X) of the some pixels, the one pixel and the some pixels being located in a predetermined region. In other words, the fourth sub pixels (X) of the pixels located in the predetermined region have substantially identical luminance without depending on RGB sub pixels of the pixels.

Therefore, the display device (display method) in accordance with the present invention can independently determine tone values of the fourth sub pixels in accordance with tones of corresponding RGB sub pixels, and therefore can solve problems of conventional techniques, i.e., such problems that a display quality of the display device is degraded and the display device unclearly displays outlines of a displayed image.

Note that the predetermined region may be a whole region of or part of a screen of the display panel, and is not limited to a particular range.

### Advantageous Effects of Invention

As described above, a display device in accordance with the present invention includes: obtaining means for obtaining RGB data; and first converting means for setting luminance of a fourth sub pixel (X) of one pixel of the pixels to be substantially identical with luminance of fourth sub pixels (X) of some pixels of the pixels in the case where the RGB data obtained by the obtaining means is converted into RGBX data for each pixel, the one pixel and the some pixels being located in a predetermined region.

As described above, a display method with use of a display device in accordance with the present invention includes the steps of: obtaining RGB data; and setting luminance of a fourth sub pixel (X) of one pixel of the pixels to be substantially identical with luminance of fourth sub pixels (X) of some pixels of the pixels in the case where the RGB data obtained by the obtaining means is converted into RGBX data for each pixel, the one pixel and the some pixels being located in a predetermined region.

Therefore, the display device, which includes a display panel including pixels each of which includes four sub pixels is capable of clearly displaying outlines of a displayed image.

### BRIEF DESCRIPTION OF DRAWINGS

FIG. 1 is a block diagram illustrating a structure of a display device in accordance with this embodiment.

FIG. 2 is a flow chart showing a flow of processes in which a display device in accordance with this embodiment converts RGB data into RGBW data and displays an image to a display panel on the basis of the RGBW data.

FIG. 3 is a view illustrating display of outlines displayed with use of pixels each including three sub pixels of RGB.

FIG. 4 is views each illustrating display of outlines with use of pixels each including four sub pixels of RGBW which are arrayed in a square shape. (a) of FIG. 4 illustrates the case where white (W) is turned on, and (b) of FIG. 4 illustrates white (W) is turned off.

FIG. 5 is views each illustrating display of outlines with use of pixels each including four sub pixels of RGBW which are arrayed in stripes. (a) of FIG. 5 illustrates the case where white (W) is turned on, and (b) of FIG. 5 illustrates white (W) is turned off.

FIG. 6 is a block diagram illustrating a structure of another display device in accordance with another embodiment.

### DESCRIPTION OF EMBODIMENTS

### Embodiment 1

The following description will discuss a display device 100 of Embodiment 1 with reference to drawings. In the following description, identical members and identical constituents are denoted by identical reference signs. Those identical members and identical constituents have the same functions and the same names. Therefore, detailed description thereof will not be described repeatedly.

(Structure of Display Device 100)

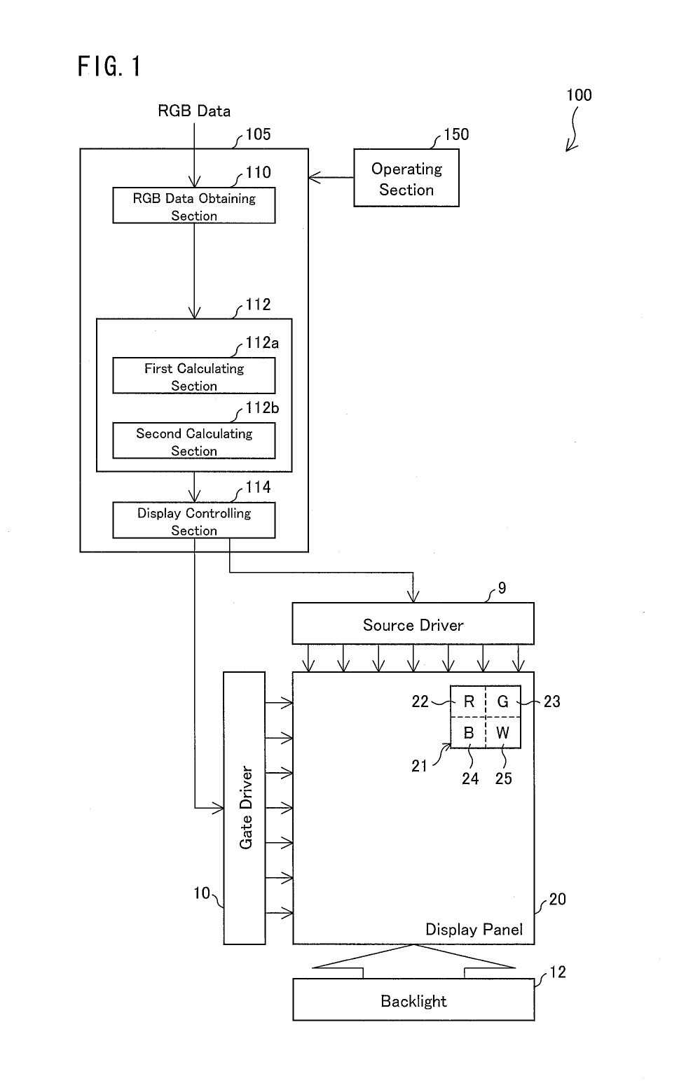

FIG. 1 is a block diagram illustrating a structure of the display device 100 in accordance with one embodiment of the present invention.

As shown in FIG. 1, the display device 100 includes a source driver 9, a gate driver 10, a backlight 12, a display panel 20, and a controller 105.

The display device 100 includes a pixel array of R (red), G (green), B (blue), and W (white). In Embodiment 1, a pixel 21 is constituted by four sub pixels 22, 23, 24, and 25 as shown in FIG. 1, and the plurality of pixels 21 (not shown) are arranged in matrix in the display panel 20.

Note that Embodiment 1 is described on the assumption that the display device 100 is a liquid crystal display device, however, the display device 100 is not limited to the liquid crystal display device, and may be a PDP (plasma display panel), an organic EL (organic light emitting display) panel, or the like.

Further Embodiment 1 is described on the assumption that the four sub pixels are R (red), G (green), B (blue), and W (white), however, the four sub pixels may be R (red), G (green), B (blue), and Y (yellow), or R (red), G (green), B (blue), and G (green). Furthermore, Embodiment 1 can be also applied in the case of five or more sub pixels (e.g., RGBYC).

The individual pixels 21 of the display panel 20 are connected to the source driver 9 via a plurality of source lines, respectively, and are connected to the gate driver 10 via a plurality of gate lines, respectively. Consequently, by controlling voltages applied to the individual pixels 21, transmittance of light in the individual sub pixels is changed.

Since the display device 100 includes RGB sub pixels, a desired color is reproduced by mixing three colors of red, green, and blue. These colors are obtained by arranging color filters of red, green, and blue in such a manner that, for example, the color filters correspond to RGB sub pixels, respectively, and light emitted from the backlight 12 provided at a back surface of the display panel 20.

Since the pixel 21 includes the W sub pixel 25 in addition to the RGB sub pixels 22, 23, and 24, it is possible to make luminance of a displayed image higher than that of a display panel including only RGB sub pixels.

Note that, in FIG. 1, the RGBW sub pixels 22, 23, 24, and 25 are arranged in matrix (arrayed in a square shape) of two rows and two columns such that the R sub pixel 22, the G sub pixel 23, the B sub pixel 24, and the W sub pixel 25 are arranged at the upper left side, the upper right side, the lower left side, and the lower right side, respectively. However, arrangement of sub pixels is not limited thereto.

For example, array of sub pixels may be (I) a stripe type in which color filters having the identical color are arrayed in the same pixel column, (II) a mosaic type in which color filters of red, green, blue, and white are arrayed by turns in column and row directions, or (III) a delta type in which unit pixels are arrayed in the column direction so as to form indentations, i.e., in which color filters of red, green, blue, and white are arrayed by turn in the column direction so as to be in zigzag. Those array methods each have own characteristics. For example, in the case where an image is displayed while each four unit pixels including the color filters of red, green, blue, and white are regarded as a single dot, the array of the delta type is advantageous in displaying a circle and a diagonal line to a screen. Therefore, array of sub pixels may be selected in accordance with usage in consideration of such advantages.

The controller 105 extracts color signals of RGB and a sync signal (horizontal sync signal, vertical sync signal, and the like) from RGB data (video signals of three colors of RGB3) supplied from the outside, and converts the color signals of RGB thus extracted into color signals of RGBW (i.e., an input image constituted by RGB pixels is converted into a converted image constituted by RGBW pixels). The color signals of RGB are defined as tone data. The controller 105 controls driving of the gate driver 10 on the basis of the sync signal, and controls driving of the source driver 9 on the basis of the color signals of RGBW and the sync signal.

More specifically, the controller 105 includes at least an RGB data obtaining section (obtaining means) 110, a calculating section 112, and a display controlling section 114.

The RGB data obtaining section 110 obtains RGB data from an external data source. The RGB data is a signal transmitted in the form of three colors of R, G, and B into which each of color components of an image to be displayed is decomposed. Specifically, shades of each of RGB colors are expressed gradually as a tone, and various colors can be expressed by controlling tones assigned to individual colors.

In the case where 8 bit data is assigned to each of RGB colors, each color can be expressed in 255 tones. However, Embodiment 1 is not limited to this range, and the number of tones that can be expressed is changeable depending on data assigned to RGB. Examples of a data source of RGB data encompass a television tuner and a personal computer.

As described above, RGB data is designed such that RGB tones are assigned to each pixel so as to correspond to a color to be expressed, and the display device 100 achieves a desired tone by controlling transmittance of light of each sub pixel. That is, a lower tone provides a darker color due to decrease in transmittance of light, whereas a higher tone provides more vivid red, green, or blue due to increase in transmittance of light.

RGB data obtained by the RGB data obtaining section 110 is data corresponding to a pixel constituted by three sub pixels of RGB. Accordingly, in the display device 100 having pixels each constituted by four sub pixels of RGBW, it is necessary to convert the RGB data thus obtained so as to correspond to the four pixels. In the display device 100, the calculating section 112 converts RGB data into RGBW data.

More specifically, the calculating section 112 includes a first calculating section 112a (first converting means) and a second calculating section 112b (second converting means) (here, if it is not necessary to distinguish the first calculating section 112a and the second calculating section 112b, those sections 112a and 112b are simply referred to as “calculating section 112”).

In the case where the RGB data for each pixel, obtained by the RGB data obtaining section 110, is converted into RGBX data, the first calculating section 112a sets luminance of a white (W) sub pixel to be substantially identical with that of a plurality of white (W) sub pixels, including the above white sub pixel, within a predetermined region. Note that the predetermined region may be a whole region of or part of a screen of the display panel, and is not limited to a particular range.

The second calculating section 112b converts the RGB data for each pixel, obtained by the RGB data obtaining section 110, into RGBX data. That is, the second calculating section 112b calculates RGB data which are three-color video signals to convert the RGB data into RGBW data which are four-color video signals. As an example of such method of converting data, RGBW data are generated by extracting white color components from binary RGB data and then performing a halftone process on the white color components. As another example, there is a method in which (i) a minimum value of increased values of each color in RGB data is subtracted from each of the increased values, (ii) subtracted values are used as input increased values of the white components, (iii) the rest of increased values of video signals (RGB) of red, green, and blue, which are obtained by subtracting the input increased values of the white components from the increased values, are used as output signals of video signals (RGB). Note that the method of converting RGB data into RGBW data is already a publicly-known technique, so that detailed description will be omitted in Embodiment 1.

The calculating section 112 does not generate a single kind of RGBX data from RGB data, but generate a plural kinds of RGBX data. Therefore, the display controlling section 114 selects RGBX data from the plural kinds of RGBX data in accordance with a characteristic of the display device 100, and optimizes the RGBX data to thereby output the RGBX data (R′G′B′W′). For example, in the case where a single pixel is displayed as a 127th tone of an intermediate tone, there are 256 patterns such as (W=0, RGB=255), (W=1, RGB=254), . . . (W=127, RGB=127), . . . , and (W=255, RGB=0). A method of optimizing RGBX data is already publicly-known technique, so that the detailed description will be omitted in Embodiment 1.

The display controlling section 114 generates, from the RGBW data converted by the calculating section 112, an image to be displayed to the display panel 20, and then causes the display panel 20 to display the image. The RGBW data used for displaying the image that the display controlling section 114 causes the display panel 20 to display is RGBW data calculated by at least one of the first calculating section 112a and the second calculating section 112b which is/are selected by an external input via the operating section 150. Note that, in the following description, display of RGBX data converted by the first calculating section 112a is referred to also as “first display mode” and display of RGBX data converted by the second calculating section 112b is referred to also as “second display mode”.

The operating section 150 is used to input, to the controller 105, mode selection information indicating which display mode, the first display mode or the second display mode, is used to cause the display panel 20 to display the image. The operating section 150 may be constituted by, for example, a remote controller for remotely controlling the display device 100, an operation button provided to the display device 100 itself, or a mouse or keyboard connected to the display device 100. Selection signals indicating the mode selection information which has been supplied with use of the operating section 150 are sent to the display controlling section 114 via an input/output controlling section (not shown). It is therefore possible to select, with use of the display controlling section 114, a display mode to display the image from the first display mode and the second display mode. Note that the mode selection information may have, for example, information indicating that a display mode is determined depending on the type of image to be displayed (e.g., text data, photographs, moving images, etc.).

As an example, in the case where the image to be displayed to the display panel 20 is a colorful photograph, a viewer instructs the operating section 150 to display the colorful photograph in the first display mode. Meanwhile, in the case where the image to be displayed to the display panel 20 is monochrome text data, a viewer instructs the operating section 150 to display the monochrome text data in the second display mode. Further, in the case where the image to be displayed to the display panel 20 is a photograph and monochrome text data, a viewer instructs the operating section 150 to display the photograph in the first display mode and the monochrome text data in the second display mode.

Furthermore, in Embodiment 1, the display controlling section 114 can switch between display in the first display mode and display in the second display mode with use of a dimming function. Further, the display controlling section 114 can perform display in the first display mode and in the second display mode within the same screen (detailed description thereof will be described below).

The display controlling section 114 includes a timing controlling section (not shown). The timing control section generates control signals corresponding to the RGBW data, and transmits the control signals to the source driver 9 and the gate driver 10. Examples of the control signals encompass a source start signal, a source clock signal, a gate start signal, and a gate clock signal.

In accordance with the received control signals, the source driver 9 and the gate driver 10 apply voltages to the sub pixels 22, 23, 24, and 25 of R, G, B, and W arranged in each of the pixels 21 to control transmittance of each of the pixels 21, thereby expressing colors.

The backlight 12 is controlled by a backlight controlling section (not shown), and is caused to emit light toward the display panel 20. In Embodiment 1, light emitted from the backlight 12 is not limited as long as it is white light. Examples of the light source of the backlight 12 encompass electroluminescence (EL), cold cathode fluorescent lamp (CCFL), and light-emitting diode (LED). The display panel 20 displays an image on the basis of an RGBW data signal, a sync signal, and a power supply voltage signal inputted via the display controlling section 114. The sync signal and the power supply voltage signal may be generated from an LSI on which the controller 105 is provided. The LSI including the controller 105 may be mounted on a substrate of the display panel, a glass of the display panel, or a TCP.

The display device 100 configured as described above may be used in various devices such as a television receiver, a personal computer, a mobile phone, and a game machine.

(Operation of Display Device 100)

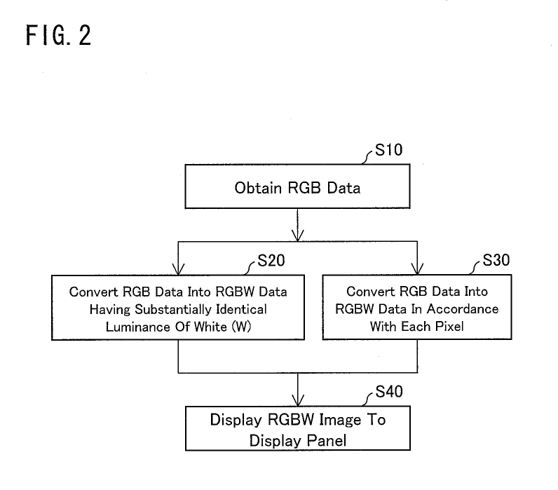

The following description will discuss, with reference to FIG. 2, a flow of processes in which the display device 100 converts RGB data into RGBW data and displays an image to the display panel 20 on the basis of the RGBW data. FIG. 2 is a flow chart showing a flow of processes in which the display device 100 converts RGB data into RGBW data and displays an image to the display panel 20 on the basis of the RGBW data.

First, the RGB data obtaining section 110 obtains RGB data from, for example, an external data source such as a television tuner or a personal computer (S10). Shades of each of RGB colors of the RGB data are expressed gradually as a tone, and various colors can be expressed by controlling tones assigned to individual colors. The RGB data obtaining section 110 outputs the RGB data thus obtained to the first calculating section 112a and the second calculating section 112b.

Note that, in the case where a calculating section (the first calculating section 112a or the second calculating section 112b) which does not need to process the image has been set in advance on the basis of an input via the operating section 150, the RGB data obtaining section 110 may outputs the RGB data thus obtained to the first calculating section 112a or the second calculating section 112b which needs the RGB data thus obtained. Thus, the calculating section 112 can omit an unnecessary process and therefore can reduce throughput. Note that, Steps of S20 and below will be described on the assumption that both the first calculating section 112a and the second calculating section 112b convert RGB data into RGBX data.

Next, in the case where RGB data of each pixel, obtained by the RGB data obtaining section 110, is converted into RGBX data, the first calculating section 112a sets luminance of a white (W) sub pixel to be substantially identical with that of a plurality of white (W) sub pixels, including the above white sub pixel, within a predetermined region. Note that the predetermined region may be a whole region of or part of a screen of the display panel, and is not limited to a particular range (S20).

Luminance of a white (W) sub pixel determined by the first calculating section 112a may be any of luminance of white, black, and an intermediate tone therebetween. Note, however, that tones at both ends (white and black) are superior to the intermediate tone in terms of a viewing angle characteristic of a liquid crystal display device. Further, white is used only for limited images (use cases are limited). Meanwhile, since black display is performed with use of remaining three sub pixels of RGB, a display quality of the black display becomes very close to that of black display with use of conventional three sub pixels of RGB. Therefore, it is preferred that the first calculating section 112a converts the RGB data into RGBX data so that display of white (W) becomes black.

The term “substantially identical” does not exactly means “identical” in some cases, and may have a certain range of luminance values. This is because the display device 100 can improve outlines of a displayed image even if the luminance of the white (W) sub pixel is “substantially identical” with that of the plurality of white (W) sub pixels. Note that the luminance of the white sub pixel is determined to be “substantially identical” with that of the white sub pixels as long as (i) the luminance of the white sub pixel changes periodically and (ii) a ratio of the luminance of the white sub pixel to an average luminance of the white sub pixels in each period falls within the range of 0% to 220%.

For each data pixel, the second calculating section 112b converts the RGB data, obtained by the RGB data obtaining section 110, into the RGBX (S30). A method of converting the RGB data into the RGBX may be performed by any conventional technique, and therefore detailed description thereof is omitted.

The first calculating section 112a and the second calculating section 112b individually output the RGBW data to the display controlling section 114.

The display controlling section 114 generates, from the RGBW data converted by the calculating section 112, an image to be displayed to the display panel 20, and then causes the display panel 20 to display the image (S40).

In this way, the display device 100 converts the RGB data into the RGBW data, and displays the image to the display panel 20 on the basis of the RGBW data.

(Effect of Display Device 100)

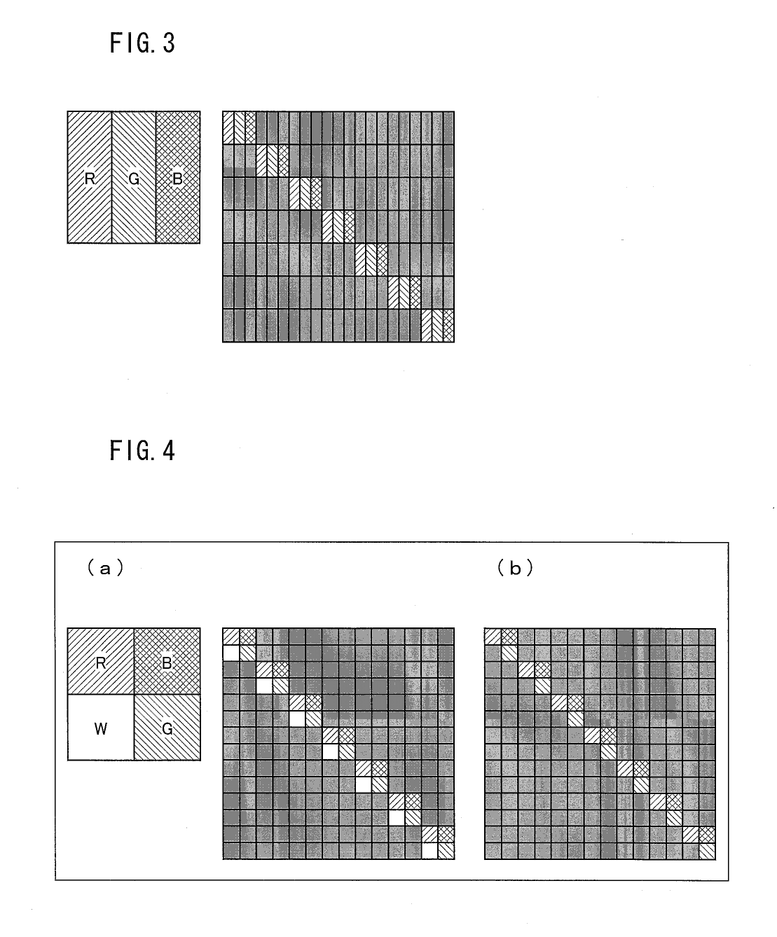

The following description will discuss an effect obtained by the display device 100 with reference to FIG. 3 to FIG. 5.

FIG. 3 is a view illustrating display of outlines displayed with use of pixels each including three sub pixels of RGB. Generally, display by pixels each including three sub pixels of RGB has a high display quality and is advantageous in viewing angle characteristic in the case where the display is performed in a liquid crystal display.

FIG. 4 is views each illustrating display of outlines with use of pixels each including four sub pixels of RGBW which are arrayed in a square shape. (a) of FIG. 4 illustrates the case where white (W) is turned on, and (b) of FIG. 4 illustrates white (W) is turned off

As illustrated in (a) of FIG. 4, in the case where the outlines are displayed with use of the pixels each including four sub pixels of RGBW which are arrayed in a square shape, white (W) sub pixels which are bright sub pixels are positioned at left edges of pixels, and therefore the white sub pixels at the left edges are conspicuous. Further, those white (W) sub pixels are displayed every two lines, so that the white sub pixels are recognized as grains, which results in reduction in display quality.

More specifically, in the case where the pixels each including four sub pixels of RGBW are used to perform display and outline parts of a video pattern is displayed with use of sub pixels other than conventional RGB sub pixels, the edges are differently displayed from the case of conventional RGB sub pixels. In the case of a liquid crystal display device, the viewing angle characteristic depends on a displayed tone. Therefore, some of sub pixels displayed with use of pixels each including four sub pixels of RGBW have tones different from those of sub pixels displayed with use of pixels each including three sub pixels of RGB. This changes the viewing angle characteristic. Further, in the case where the plurality of pixels in the liquid crystal display device or the like share a single light source, a luminance of a pixel is decreased as a color displayed by the pixel is closer to a primary color.

By eliminating white (W) ((b) of FIG. 4), it is possible to achieve display closer to the display of the outlines with use of pixels each including conventional three sub pixels of RGB. Therefore, even if the pixels each including four sub pixels of RGBW are used to display outlines, it is possible to (i) avoid a change of the outlines of an image, which change is peculiarly caused by the sub pixels of RGBW, (ii) maintains a high display quality, and (iii) keeps an excellent viewing angle characteristic in the case where such display is performed in a liquid crystal display.

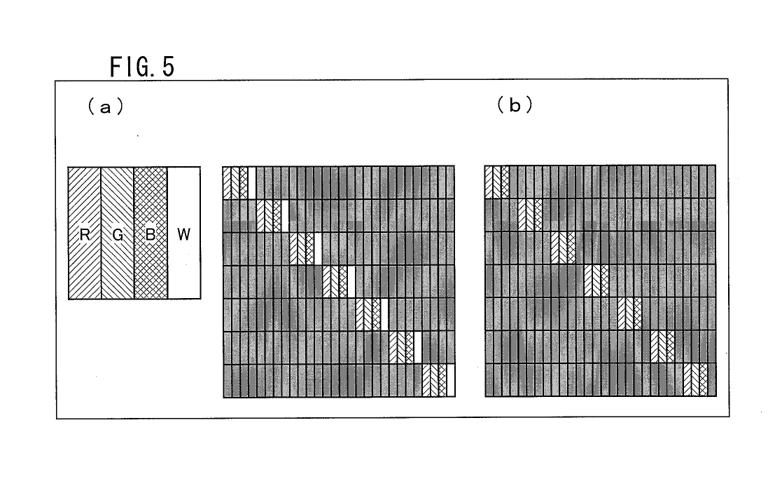

FIG. 5 is views each illustrating display of outlines with use of pixels each including four sub pixels of RGBW which are arrayed in stripes. (a) of FIG. 5 illustrates the case where white (W) is turned on, and (b) of FIG. 5 illustrates white (W) is turned off.

Also in (a) of FIG. 5, white (W) bright pixels which are bright pixels are positioned at right edges of pixels, and therefore the right edges are conspicuous. By eliminating white (W) ((b) of FIG. 5), it is possible to achieve display closer to the display of the outlines with use of pixels each including conventional three sub pixels of RGB. Therefore, even if the pixels each including four sub pixels of RGBW are used to display outlines, it is possible to (i) avoid a change of the outlines of an image, which change is peculiarly caused by the sub pixels of RGBW, (ii) maintains a high display quality, and (iii) keeps an excellent viewing angle characteristic in the case where such display is performed in a liquid crystal display. This effect can be also obtained in the case of using another arraying method such as the mosaic type or the delta type. In particular, in a case where an edge subjected to a sub pixel rendering process for pixels arrayed in stripes is displayed in an RGBW stripe array, such display of the edge is closer to display of an edge subjected to the sub pixel rendering process in an RGB stripe array.

Further, in some cases, it is more preferable for a viewer that a displayed image be displayed while white (W) is being on. As to this point, the display device 100 can switch between the first display mode and the second display mode depending on circumstances, thereby achieving a display device which can display various display scenes. Such switching between two display modes may be performed manually by a viewer via the operating section 150, or may be performed by a data characteristic analyzing section (converting means) 111 described below.

(Structure of Four Sub Pixels)

The following description will discuss various structures of a sub pixel.

In the display device 100, a single pixel includes, in addition to the pixels of RGB, a fourth sub pixel of white (W). Therefore, since white (W) is the brightest sub pixel, brightness of a whole screen itself can be improved.

In this case, the sub pixels of red (R) and green (G) may be structured to be larger in area than the sub pixel of blue (B).

With this structure, reduction in luminance of yellow is visually conspicuous the most in the sub pixels of RGBW. However, by increasing the areas of the sub pixels of R and G than that of the sub pixel of B, it is possible to improve display of yellow. This makes it possible to display an image while developing yellow clearly.

The area of the sub pixel of B is 1.2 times to 2.0 times as large as each of the areas of the sub pixels of R and G. If a ratio of the area of the sub pixel of B to the areas of the sub pixels of R and G is less than this value, effects such as improvement in display of yellow to clearly develop yellow are reduced. On the contrary, if the ratio is larger than this value, display of yellow is improved, however, luminance of green is decreased. Therefore, it is preferable that the area of the B sub pixel be 1.2 times to 2.0 times as large as each of the areas of the R and G sub pixels.

In the display device 100, each pixel may include, in addition to the pixels of RGB, a fourth sub pixel of yellow (Y). A reason of this is described below.

Brightness of a color is determined by a luminance ratio of the color to white. In the case where the four sub pixels are RGBW, a luminance ratio of the yellow display (when R and G sub pixels are turned on) to the white display (when all RGBW sub pixels are turned on) is reduced, by a lightening amount of W sub pixels, from a luminance ratio of the yellow display (when R and G sub pixels are turned on) to the white display (when all RGBW sub pixels are turned on) in a conventional RGB panel. Generally, in the case where a luminance ratio of a color to white is reduced at a certain percentages, reduction in luminance of the color can be recognized more easily by human eyes as the original color was higher. Therefore, in the case of display with use of RGBW, yellow looks darker because yellow has the highest luminance. However, in the case where the fourth sub pixel (X) is yellow (Y), luminance of yellow with respect to white is increased. This makes it possible to improve a display quality.

In this case, the blue (B) sub pixel may be structured to be larger in area than the red (R) and green (G) sub pixels. With this structure, in the case where the four sub pixels are RGBY, the white display displayed when all RGBY sub pixels are on becomes yellowish. In view of the circumstances, a sub pixel of B serving as a complementary color is set to be larger in area than R and G sub pixels, thereby complementing the white display. This makes it possible to decrease a yellowish tinge occurring when the white display is performed while the RGBY pixels are being on.

It is preferable that the area of the blue (B) sub pixel be 1.2 times to 2.0 times as large as the areas of the red (R) and green (G) sub pixels. If the ratio of the area of the blue (B) sub pixel to the areas of the red (R) and green (G) sub pixels is less than this value, the above effects are reduced. On the contrary, if the ratio is larger than this value, reduction in luminance of red display or green display becomes conspicuous. Therefore, it is preferable that the area of the blue (B) sub pixel be 1.2 times to 2.0 times as large as the areas of the red (R) and green (G) sub pixels.

Furthermore, in the display device 100, a single pixel may include, in addition to the pixels of RGB, a fourth sub pixel of green (G).

With this structure, in the case where the fourth sub pixel (X) is green (G), the display device 100 can be installed at a low cost because green (G) is a color which is used in the conventional RGB. Further, by using green (G) having the highest luminance among RGB, a luminance improvement effect can be maximized.

By changing the structure of the sub pixels variously, it is expected that various structures thus changed produce different effects. Further, in this case, it is possible to (i) avoid a change of the outlines of an image, which change is peculiarly caused by the sub pixels of RGBW, (ii) maintains a high display quality, and (iii) keeps an excellent viewing angle characteristic in the case where such display is performed in a liquid crystal display.

(Dimming)

The following description will discuss display control with use of a dimming function.

It is known that, in the case where switching from the first display mode to the second display mode (or vice versa) is performed quickly, a flicker occurs in a display screen, and this flicker reduces a display quality.

In view of the circumstances, the display device 100 is structured such that the display controlling section 114 switches between the first display mode and the second display mode with use of the dimming function. Therefore, the switching from the first display mode to the second display mode (or vice versa) is performed slowly, so that it is possible to avoid occurrence of flickers as much as possible.

A method of performing the dimming function described above is not particularly limited, and the method may be performed as follows in the case where, for example, the four sub pixels are RGBW. In the case where W in an RGBW lightning mode is changed to display black, brightness of W is reduced, and lightening of remaining RGB sub pixels is determined in accordance with the brightness of W thus reduced so as to maintain a target display quality. This process is repeatedly performed until the W sub pixels are turned off. The display controlling section 114 performs the switching with use of the dimming function as described above, so that it is possible to turn off the W sub pixels (i.e., to shift a display mode of the W sub pixels to black display) without reducing the display quality.

Note that, while a time required for dimming depends on external environments and/or a viewer's preference, a preferable time is about 30 ms to 2 s. Further, a viewer can supply an input via the operating section 150 during the time required for dimming. This makes it possible to provide a more convenient display device 100 to a viewer. Assuming that the dimming function is not performed when the time is changed immediately in a next frame (in the case of 1 frame), the time required for dimming is 30 ms when the dimming function is performed for two or more frame periods, meanwhile, the time required for dimming is 2S in order to perform the dimming function so rapidly that a change in luminance caused by the dimming function is hardly recognized.

(Two modes in One Screen)

The following description will discuss the case where the first display mode and the second display mode are displayed in the same screen.

Generally, in the case where display is performed with use of the pixels each including four sub pixels, it is possible to display a brighter image as compared with the case where display is performed with use of pixels each including the conventional three sub pixels of RGB. In the case where brightness of display with use of the pixels each including four sub pixels is identical with that of display with use of pixels each including the conventional three sub pixels, the pixels each including four sub pixels can perform display at a lower power consumption. On the contrary, the RGB display is advantageous in display quality.

In this point, in the display device 100, the display controlling section 114 causes the first display mode and the second display mode to be displayed in the same screen. Therefore, in the display device 100, it is possible to check both the first display mode and the second display mode in the same screen. This makes it possible to simultaneously provide merits of the two display modes to a viewer.

Note that, as an example where the first display mode and the second display mode are displayed in the same screen, there is an example where a photograph is displayed in the first display mode whereas text data is displayed in the second display mode. This makes it possible to simultaneously produce such effects that the photograph is displayed at a high display quality whereas the text data is displayed at a lower power consumption.

### Embodiment 2

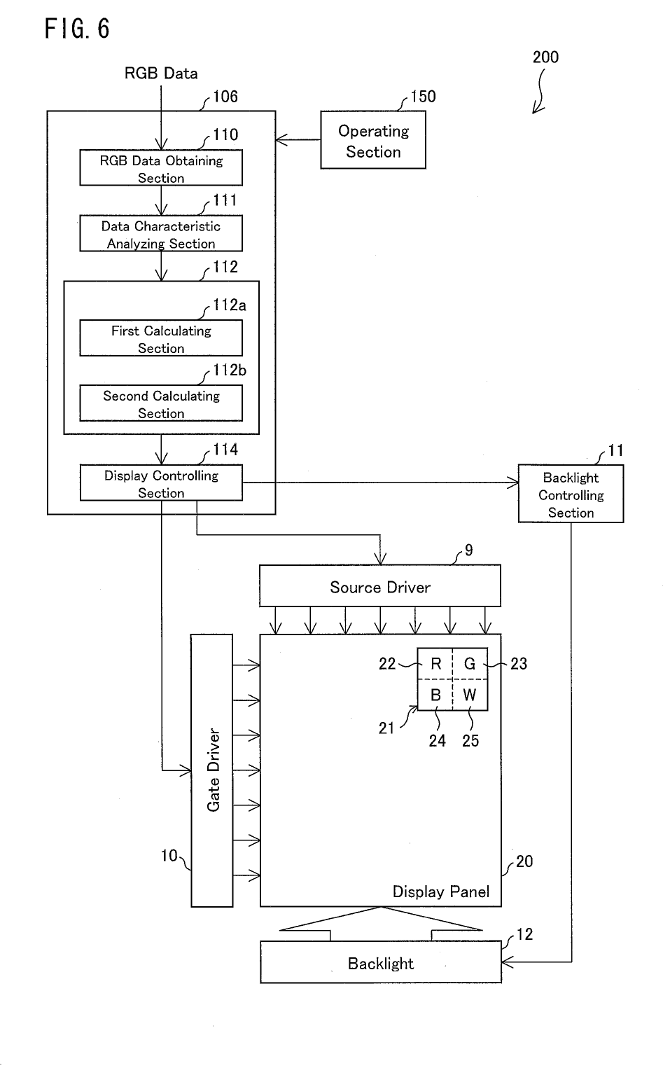

The following description will discuss a display device 200 according to Embodiment 2 with reference to FIG. 6. Note that the description, which has been already made with reference to FIG. 1 etc., will be omitted.

FIG. 6 is a block diagram illustrating a structure of a display device 200 in accordance with Embodiment 2.

As shown in FIG. 1, the display device 100 includes the source driver 9, the gate driver 10, the backlight 12, the display panel 20, the backlight controlling section 11, and the controller 106.

The backlight controlling section 11 are cooperated with the display controlling section 114 to regulate the luminance of the backlight 12.

The controller 106 includes a data characteristic analyzing section 111 in addition to the RGB data obtaining section 110, the calculating section 112, and the display controlling section 114.

The data characteristic analyzing section 111 obtains RGB data from the RGB data obtaining section 110 and analyzes a characteristic of the RGB data. For example, the data characteristic analyzing section 111 is operated as follows.

In the case of RGBW, it is easy to display a color brightly as the color becomes pale, and a luminescence efficiency of a single sub pixel having a certain color is remarkably reduced as the color becomes vivid. In view of the circumstances, the data characteristic analyzing section 111 obtains the RGB data from the RGB data obtaining section 110, and performs calculation to equalize vividness of the pixels (e.g., a minimum tone/a maximum tone of each pixel) in the whole screen. The data characteristic analyzing section 111 determines whether an average value is equal to or larger than a predetermined value or less than the predetermined value. In the case where the average value is equal to or larger than the predetermined value, the data characteristic analyzing section 111 instructs the calculating section 112 to switch off the W sub pixel to display black. On the contrary, in the case where the average value is less than the predetermined value, the data characteristic analyzing section 111 instructs the calculating section 112 to perform display while all the RGBW sub pixels are being on. The predetermined value is optimally 50% to 80%. If the predetermined value is less than 50% to 80%, the luminance improvement effect of RGBW cannot be sufficiently produced, whereas, if the predetermined value is larger than 50% to 80%, display is extremely deteriorated.

Alternatively, the data characteristic analyzing section 111 may be operated as follows.

The data characteristic analyzing section 111 obtains the RGB data from the RGB data obtaining section 110, converts the RGB data into YCbCr (luminance/hue), and separates chromaticness information and luminance information. Then, the data characteristic analyzing section 111 obtains C, which is a value indicating a chromaticness, by calculating C=(cb²+cr²)^{0.5} with use of Cb and Cr. Here, cb is a Cb value of the pixel with respect to a maximum value of Cb which could be obtained from the above calculation, and cr is a Cr value of the pixel with respect to a maximum value of Cr which could be obtained from the above calculation. Further, in the case where an average value of C is equal to or larger than a predetermined value in the whole screen, the data characteristic analyzing section 111 instructs the calculating section 112 to turn off the W sub pixel to display black. On the contrary, in the case where the average value is less than the predetermined value, the data characteristic analyzing section 111 instructs the calculating section 112 to switch on all the RGBW sub pixels. The predetermined value is optimally 50% to 80%. If the predetermined value is less than 50% to 80%, the luminance improvement effect of RGBW cannot be sufficiently produced, whereas, if the predetermined value is larger than 50% to 80%, display is extremely deteriorated.

As described above, the data characteristic analyzing section 111 obtains the RGB data from the RGB data obtaining section 110, and analyzes characteristics (a minimum tone/a maximum tone of each pixel, chromaticness information, and the like) of the RGB data, and therefore can transmit a predetermined instruction to the calculating section 112, whereas the display controlling section 114 can perform display on the basis of a result of calculation by the calculating section 112. To put it another way, the display device 200 automatically maintains a preferable display quality in accordance with the characteristics of the RGB data.

(A Plurality of Backlights)

In the display device 200, the backlight 12 may be divided into a plurality of small blocks. In this case, control of switching on/off of each block is performed by the backlight controlling section 11, and the backlight controlling section 11 controls the backlight 12 in response to an instruction from the display controlling section 114.

As described above, the display controlling section 114 switches between the first display mode and the second display mode, and performs display control with use of a dimming function and display control in which the first display mode and the second display mode are simultaneously displayed in a single screen. The backlight 12 are divided into a plurality of small blocks, and then backlight of each block is controlled by the display controlling section 114 via the backlight controlling section 11. This makes it possible to control a backlight of a pixel group corresponding to each block, so that display of outlines of a displayed image can be improved for each pixel group. Further, since the backlight is controlled for each pixel group, power consumption can be reduced as much as possible.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

Finally, blocks of the display devices 100, 200 can be configured by means of hardware logic or can alternatively be realized by software with use of a CPU.

Specifically, the display devices 100, 200 each include: a CPU (central processing unit) for executing commands of a control program to realize each function; a ROM (read only memory) which stores the program; a RAM (random access memory) in which the program is developed in an executable format; and a storage device (recording medium), such as a memory, which stores the program and various kinds of data.

Further, the object of the present invention can be also realized in such a manner that: a recording medium is provided to the display devices 100, 200, which recording medium has stored program codes (execution mode program, intermediate code program, and source program) of a display program, serving as software for realizing the aforementioned functions, so that the program codes are readable by a computer; and the program codes stored in the recording medium are read out and carried out by the computer (or CPU or MPU).

Examples of the recording medium encompass: tapes such as a magnetic tape and a cassette tape; disks such as magnetic disks (e.g., a floppy (registered trademark) disk and a hard disk) and optical disks (e.g., a CD-ROM, an MO, an MD, a DVD, and a CD-R); cards such as an IC card (including a memory card) and an optical card; and semiconductor memories (e.g., a mask ROM, an EPROM, an EEPROM, and a flash ROM).

Further, the display devices 100, 200 may be configured to be connect to a communication network, and the program code may be supplied via the communication network. The communication network is not particularly limited, and examples of the communication network encompass the Internet, an intranet, an extranet, a LAN, an ISDN, a VAN, a CATV communication network, a virtual private network, a telephone network, a mobile communication network, and a satellite communication network. In addition, a transmission medium constituting the communication network is not particularly limited, and examples of the transmission medium encompass: wired transmission media such as IEEE1394, a USB, a power-line carrier, a cable TV line, a telephone line, and an ADSL; and wireless transmission media such as infrared rays (e.g., IrDA and a remote controller), Bluetooth (registered trademark), 802.11 wireless, an HDR, a cell-phone network, and a satellite line, and a digital terrestrial network. Note that the present invention may be also realized by a computer data signal which has the program codes specified with electronic transmission and is embedded in a carrier wave.

### [Supplementary Explanation]

Note that features of a display device in accordance with the present invention can be also expressed as follows.

That is, a display device in accordance with the present invention may be structured to have pixels of RGB+one color, and to have a mode in which all the pixels are variable in accordance with a video signal and a mode in which, even if an input video signal is changed, luminance of a sub pixel of a particular color is kept to be constant.

Further, in the display device in accordance with the present invention, substantially constant luminance may be black.

Further, in the display device in accordance with the present invention, a sub pixel other than RGB sub pixel may be W.

Further, in the display device in accordance with the present invention, the sub pixel may be Y.

Further, in the display device in accordance with the present invention, the sub pixel may be G.

Further, in the display device in accordance with the present invention, the RGB sub pixels may be different from each other in an area ratio, and the B sub pixel may be larger than any one of the other two sub pixels.

Further, in the display device in accordance with the present invention, the RGB sub pixels are different from each other in an area ratio, the R and G sub pixels may be larger than the B sub pixel.

Further, the display device in accordance with the present invention may be structured such that the modes can be automatically switched on or off on the basis of input image data. In this case, the input image data may be divided into chromaticness and luminance information.

Further, the display device in accordance with the present invention may be structured such that a single screen is divided into two areas, and one area displays an image in the mode in which all the pixels are variable whereas the other area displays an image in the mode in which luminance of a sub pixel of a particular color is kept to be constant.

Further, the display device in accordance with the present invention may include a plurality of light sources.

Further, the display device in accordance with the present invention may be structured to perform a dimming function in the case where the two modes are switched.

Further, in the display device in accordance with the present invention, the first converting means may convert the RGB data into RGBX data in which the fourth sub pixel (X) displays black.

In the case where display is performed with use of pixels each including four sub pixels, it is possible to display an image more brightly as compared with the case where display is performed with use of pixels each having conventional three sub pixels of RGB. Further, in the case where brightness of display with use of the pixels each including four sub pixels is identical with that of display with use of pixels each including the conventional three sub pixels, the pixels each including four sub pixels can perform display at a lower power consumption. Meanwhile, display of outlines of a displayed image is deteriorated in the case where display is performed with use of pixels each including four sub pixels, as compared with the case where display is performed with use of pixels each having conventional three sub pixels.

In view of the circumstances, the fourth sub pixels is caused to display black, and remaining three sub pixels of RGB display an image, so that it is possible to achieve a display quality which is very close to a display quality of pixels each including three conventional RGB sub pixels.

Further, the display device in accordance with the present invention may include: second converting means for independently determining the luminance of the fourth sub pixel (X) of the one pixel and the luminance of the fourth sub pixels (X) of the some pixels in the case where the RGB data obtained by the obtaining means is converted into the RGBX data for each pixel; and display controlling means for carrying out a dimming process when a display mode is switched between a first display mode and a second display mode, the first display mode being a display mode in which the RGBX data converted by the first converting means is displayed, the second display mode being a display mode in which the RGBX data converted by the second converting means is displayed.

In the case where switching from display in the first display mode to display in the second display mode (or vice versa) is performed in a moment, a flicker occurs in a display screen, and this flicker reduces a display quality.

As to this point, in the display device in accordance with the present invention is structured to perform a dimming function in a case where the display controlling means switches between the display in the first display mode and the display in the second display mode while the first display mode or the second display mode. Therefore, the switching from the display in the first display mode to the display in the second display mode (or vice versa) is performed while a tone is being gradually changed. This makes it possible to avoid occurrence of flickers as much as possible.

Note that the method of performing the dimming function is not particularly limited. As an example of the method, the case where the four sub pixels are RGBW will be described. In the case where W in an RGBW lightning mode is changed to display black, the number of lightened W sub pixels is reduced, and lightening of remaining RGB sub pixels is determined in accordance with the number thus reduced so as to maintain a target display quality. This process is repeatedly performed until the W sub pixels are turned off. The display controlling means performs the switching slowly with use of the dimming function as described above, so that it is possible to turn off the W sub pixels (i.e., to shift a display mode of the W sub pixels to black display) without reducing the display quality.

Note that a change ratio etc. of the tone which is gradually changed in such a dimming process may be adjusted depending on external environments and/or a viewer, so that the change ratio etc. are not particularly limited to a particular value.

Further, the display device in accordance with the present invention may include: second converting means for independently determining the luminance of the fourth sub pixel (X) of the one pixel and the luminance of the fourth sub pixels (X) of the some pixels in the case where the RGB data obtained by the obtaining means is converted into the RGBX data for each pixel; and display controlling means for simultaneously displaying a first display mode and a second display mode in the same screen, the first display mode being a display mode in which the RGBX data converted by the first converting means is displayed, the second display mode being a display mode in which the RGBX data converted by the second converting means is displayed.

Generally, in the case where display is performed with use of the pixels each including four sub pixels, it is possible to display a brighter image as compared with the case where display is performed with use of pixels each including the conventional three sub pixels of RGB. In the case where brightness of display with use of the pixels each including four sub pixels is identical with that of display with use of pixels each including the conventional three sub pixels, the pixels each including four sub pixels can perform display at a lower power consumption. On the contrary, the RGB display is advantageous in display quality.

In this point, in the display device in accordance with the present invention, the display controlling means causes the display in the first display mode and the display in the second display mode to be displayed in the same screen. Therefore, in the display device in accordance with the present invention, it is possible to check both the display in the first display mode and the display in the second display mode in the same screen. This makes it possible to simultaneously provide merits of the two display modes to a viewer.

Note that, as an example where the display in the first display mode and the display in the second display mode are displayed in the same screen, there is an example where a photograph (in the first display mode) and text data (in the second display mode) are displayed in the same screen.

Further, in the display device in accordance with the present invention, the fourth sub pixel (X) may be white (W).

White (W) sub pixel is a brightest sub pixel, using the white sub pixel can improve brightness of the whole screen more than using another color pixel.

Further, in the display device in accordance with the present invention, the red (R) and green (G) sub pixels may be larger in area than the blue (B) sub pixel.

Reduction in luminance of yellow is visually conspicuous the most in the sub pixels of RGBW. However, by increasing the areas of the sub pixels of R and G than that of the sub pixel of B, it is possible to improve display of yellow. This makes it possible to display an image while developing yellow clearly.

Further, in the display device in accordance with the present invention, the fourth sub pixel (X) may be yellow (Y).

Brightness of a color is determined by a luminance ratio of the color to white. In the case where the four sub pixels are RGBW, a luminance ratio of the yellow display (when R and G sub pixels are turned on) to the white display (when all RGBW sub pixels are turned on) is reduced, by a lightening amount of W sub pixels, from a luminance ratio of the yellow display (when R and G sub pixels are turned on) to the white display (when all RGBW sub pixels are turned on) in a conventional RGB panel. Generally, in the case where a luminance ratio of a color to white is reduced at a certain percentages, reduction in luminance of the color can be recognized more easily by human eyes as the original color was higher. Therefore, in the case of display with use of RGBW, yellow looks darker because yellow has the highest luminance.

However, in the case where the fourth sub pixel (X) is yellow (Y), luminance of yellow with respect to white is increased. This makes it possible to improve a display quality.

Further, in the display device in accordance with the present invention, the blue (B) sub pixel may be structured to be larger in area than the red (R) and green (G) sub pixels.

In the case where the four sub pixels are RGBY, the white display displayed when all RGBY sub pixels are on becomes yellowish. In view of the circumstances, a sub pixel of B serving as a complementary color is set to be larger in area than R and G sub pixels, thereby complementing the white display. This makes it possible to decrease a yellowish tinge occurring when the white display is performed while the RGBY pixels are being on.

Further, in the display device in accordance with the present invention, the fourth sub pixel (X) may be green (G).

With this structure, in the case where the fourth sub pixel (X) is green (G), the display device can be installed at a low cost because green (G) is a color which is used in the conventional RGB. Further, by using green (G) having the highest luminance among RGB, a luminance improvement effect can be maximized.

Further, in the display device in accordance with the present invention, the display device may include the display controlling means for automatically switching between display in the first display mode and display in the second display mode in accordance with a data characteristic of the RGB data.

Further, the display device in accordance with the present invention may be structured such that the data characteristic is chromaticness of the RGB data; and whether display should be performed in the first display mode or the second display mode is determined in accordance with a degree of the chromaticness.

Whether or not the display is performed in the first display mode or in the second display mode is determined in accordance with the chromaticness, the display device of the present invention can automatically maintain a preferable display quality in accordance with the chromaticness.

The display device may be a liquid crystal display device.

In some cases, display of the outlines of a displayed image is different between the case where display is performed with use of pixels each including all four sub pixels and the case where display is performed with use of pixels each including conventional three RGB sub pixels. Further, in the case where the display is performed with use of the pixels each including all four sub pixels and the display device is a liquid crystal type, there arise problems that a viewing angle characteristic becomes bad, luminance of a single color reduces, and the like, as compared with the display device each pixel of which includes the conventional three sub pixels.

In this point, the display device in accordance with the present invention is applicable to a liquid crystal display device. Therefore, it is possible to solve the various problems that the viewing angle characteristic becomes bad, the luminance of a single color reduces, and the like, even if the display is performed with use of pixels each including four sub pixels.

The display device may be structured such that the display device includes a plurality of light sources of a backlight; and backlight control is performed for each group of the plurality of light sources, the each group being located in each predetermined region.

With this structure, it is possible to control backlight of each pixel in the predetermined region, and therefore possible to improve display of outlines of a displayed image for each pixel group. Further, it is possible to reduce power consumption as much as possible since backlight control is performed for each pixel group.

### INDUSTRIAL APPLICABILITY

The present invention improves display of outlines of a displayed image in a display device including a display panel each pixel of which is constituted by four sub pixels, and can be suitably applied to display devices such as an LCD, a PDP, or an organic EL display device.

### REFERENCE SIGNS LIST

9 source driver
10 gate driver
11 backlight controlling section
12 backlight
20 display panel
2a single pixel
100, 200 display device
105 controller
106 controller
110 RGB data obtaining section (obtaining means)
111 data characteristic analyzing section
112 calculating section
112a first calculating section (first converting means)
112b second calculating section (second converting means)
114 display controlling section
150 operating section

1. A display device, which includes a display panel including pixels each of which includes a red (R) sub pixel, a green (G) sub pixel, a blue (B) sub pixel, and a fourth sub pixel (X), the display device comprising
obtaining means for obtaining RGB data; and
first converting means for setting luminance of a fourth sub pixel (X) of one pixel of the pixels to be substantially identical with luminance of fourth sub pixels (X) of some pixels of the pixels in the case where the RGB data obtained by the obtaining means is converted into RGBX data for each pixel, the one pixel and the some pixels being located in a predetermined region.

2. The display device as set forth in claim 1,
wherein the first converting means converts the RGB data into RGBX data so that the fourth sub pixels (X) of the pixels are caused to display black.

3. The display device as set forth in claim 1 or 2, further comprising:
second converting means for independently determining the luminance of the fourth sub pixel (X) of the one pixel and the luminance of the fourth sub pixels (X) of the some pixels in the case where the RGB data obtained by the obtaining means is converted into the RGBX data for each pixel; and
display controlling means for carrying out a dimming process when a display mode is switched between a first display mode and a second display mode, the first display mode being a display mode in which the RGBX data converted by the first converting means is displayed, the second display mode being a display mode in which the RGBX data converted by the second converting means is displayed.

4. The display device as set forth in claim 1 or 2, further comprising:
second converting means for independently determining the luminance of the fourth sub pixel (X) of the one pixel and the luminance of the fourth sub pixels (X) of the some pixels in the case where the RGB data obtained by the obtaining means is converted into the RGBX data for each pixel; and
display controlling means for simultaneously displaying a first display mode and a second display mode in the same screen, the first display mode being a display mode in which the RGBX data converted by the first converting means is displayed, the second display mode being a display mode in which the RGBX data converted by the second converting means is displayed.

5. The display device as set forth in claim 1,
wherein the fourth sub pixels (X) of the pixels are white (W).

6. The display device as set forth in claim 5,
wherein, in the each pixel, the red (R) and green (G) sub pixels are larger in area than the blue (B) sub pixel.

7. The display device as set forth in claim 1,
wherein the fourth sub pixels (X) of the pixels are yellow (Y).

8. The display device as set forth in claim 7,
wherein, in each pixel, the blue (B) sub pixel are larger in area than the red (R) and green (G) sub pixels.

9. The display device as set forth in claim 1,
wherein the fourth sub pixels (X) of the pixels are green (G).

10. The display device as set forth in claim 3,
wherein the display device comprises the display controlling means for automatically switching between display in the first display mode and display in the second display mode in accordance with a data characteristic of the RGB data.

11. The display device as set forth in claim 10, wherein
the data characteristic is chromaticness of the RGB data; and
whether display should be performed in the first display mode or the second display mode is determined in accordance with a degree of the chromaticness.

12. The display device as set forth in claim 1,
wherein the display device is a liquid crystal display device.

13. The display device as set forth in claim 12, wherein:
the display device includes a plurality of light sources of a backlight; and
backlight control is performed for each group of the plurality of light sources, the each group being located in each predetermined region.

14. The display device as set forth in claim 3,
wherein a time required for the dimming process is 30 ms to 2 s.

15. A display method with use of a display device which includes a display panel including pixels each of which includes a red (R) sub pixel, a green (G) sub pixel, a blue (B) sub pixel, and a fourth sub pixel (X), the method comprising the steps of:
obtaining RGB data; and
setting luminance of a fourth sub pixel (X) of one pixel of the pixels to be substantially identical with luminance of fourth sub pixels (X) of some pixels of the pixels in the case where the RGB data obtained by the obtaining means is converted into RGBX data for each pixel, the one pixel and the some pixels being located in a predetermined region.
